(19) United States
(12) Patent Application Publication
(10) Pub. No.: US 2014/0149176 A1
(43) Pub. Date: May 29, 2014

(54) METHOD FOR GATHERING MARKET DATA

(71) Applicant: Vendini, Inc., San Francisco, CA (US)

(72) Inventors: Marco Matarazzi, Gualdo Tadino (IT); Andrea Sprega, Gualdo Tadino (IT)

(73) Assignee: Vendini, Inc., San Francisco, CA (US)

(21) Appl. No.: 14/050,188

(22) Filed: Oct. 9, 2013

Related U.S. Application Data
(60) Provisional application No. 61/711,635, filed on Oct. 9, 2012.

(51) Int. Cl. G06Q 30/02

(52) U.S. Cl. CPC G06Q 30/0201
USPC 705/7.29

(57) ABSTRACT

A method establishes a connection by way of a communication network between a user computing device and a ticketing application server. The user is prompted to create a user account on the computing device. The user is prompted to provide user information associated with the user account on the computing device. The user information associated with the user account is stored in a system database on the computing device.

### RELATED APPLICATIONS

The present application claims priority to U.S. provisional application No. 61/711,635, filed Oct. 9, 2012, the disclosure of which is incorporated by reference.

### BACKGROUND

1. Field of the Invention

The present invention generally concerns event ticket purchasing and processing. More particularly, the present invention relates to gathering data about users of a ticket transfer application.

2. Description of the Related Art

Traditionally, a paper ticket is issued and sold for each available seat at a live event or performance such as a concert, movie, ballet, or sporting event. A party wishing to attend the event is usually tasked with finding an available ticket, purchasing the ticket, receiving the purchased ticket (i.e., via e-mail, mail, or will call), and presenting the ticket to gain entry into the event. Alternatively, there exist mobile applications that now allow users to purchase tickets electronically. The user may present the ticket to gain entry to an event, or electronically transfer the ticket to another party for free or in exchange for payment. In order to use such mobile applications to purchase or transfer tickets, users are generally required to enter information about themselves. Information about the users may be valuable to ticket vendors, venues, advertisers, and other parties that promote live performances. Thus, there is a need for a system and method of gathering data relevant to the ticketing market, including information about parties utilizing ticketing applications.

### SUMMARY OF THE CLAIMED INVENTION

A user accesses a ticketing application using a computer or a mobile device. The user is asked to create an account. Once the account is created, the user is asked to input information about himself. The information is stored in the account in a database.

Further embodiments include a method for a user to access a ticketing application using a computer or a mobile device. The user is asked to create an account. Once the account is created, the user is asked to input information about himself. The information is stored in the account in a database. Based on the user information, the ticketing application matches upcoming events to the user that the user might be interested in attending.

### BRIEF DESCRIPTION OF THE FIGURES

FIG. 1 illustrates a computer-implemented method for gathering market data;

FIG. 2A illustrates an exemplary graphical interface for prompting a user to create a user account;

FIG. 2B illustrates an exemplary graphical interface for requesting the user enter login information;

FIG. 2C illustrates an exemplary graphical interface for prompting the user to provide user information associated with the user account on the computing device;

FIG. 2D illustrates an exemplary graphical interface for prompting the user to provide preferred contact information associated with the user;

FIG. 2E illustrates an exemplary graphical interface for prompting the user to provide payment information associated with the user on the computing device;

FIG. 2F illustrates an exemplary graphical interface for a user account;

FIG. 3 illustrates a computing system that may be used to implement the method of the present invention.

### DETAILED DESCRIPTION

Embodiments of the present invention provide a system and method for gathering information about users of a ticket transfer application.

Embodiments of the present invention may operate in a network environment in which communications may occur over the Internet, another type of remote access system (e.g., a kiosk-based terminal), a telephone, a personal digital assistant, a pulse code system, web TV, or any other device or method that can communicate data. An example may be a local area network (LAN) and/or a wide area network (WAN). Such a network environment may include a web server and computing devices associated with a plurality of users.

The steps of the method of the present invention may be embodied in hardware or software including a non-transitory computer-readable storage medium (e.g., an optical disc or memory card) having instructions executable by a processor of a computing device. The server and computing devices may include memory, communication interfaces for communicating over the network, and a processor for processing information and other relevant data. The processor may be programmable and capable of operating in accordance with programs stored on one or more of computer-readable storage media (e.g., floppy disks, hard disks, random access memory RAM, CD-ROM, ZIP disks) to communicate data to and from computing devices associated with various users. The server and computing devices may include a personal computer, a mainframe computer, network computer, portable computer, personal digital assistant, tablet computers, smartphones, and any other device capable of communicating over a network. The server and computing devices may include or be coupled to one or more internal or external data storage devices for storing data.

In a WAN environment, such as the Internet, server is controlled by software adapted to generate a response to a valid request for content information by transmitting or downloading data in the form of one or more HTML files to a requesting user computing device. It will be understood by those skilled in the art that this process involves communication through routers and other network components in addition to suitable servers, as is dictated by the particular network environment.

A user may launch or activate the method by opening or activating an application (e.g., a ticketing application) in a user computing device such as a mobile device. A ticketing application may be implemented by one or more processors that execute instructions stored in memory mediums. The executed code may result in the processor(s) generating one or more graphical interfaces.

The user computing device comprises any suitable network-adapted device capable of communicating with other devices in the network system according to an established protocol. In some embodiments, the user computing device comprises a programmable processor capable of operating in accordance with programs stored on one or more computer readable media (e.g., floppy disk, hard disk, computer network, random access memory (RAM), CD Rom, ZIP disks, or the like). The user computing device also has a display for providing a user-perceivable display (for example, but not limited to visual displays, such as cathode ray tube (CRT) displays, light-emitting-diode (LED) or liquid-crystal-diode (LCD) displays, plasma displays, audio-visual displays, touchscreen displays, other tactile displays, and a user input device (e.g., a keyboard, mouse, trackball, touch pad, microphone).

The user computing device is controlled by suitable software, including network communication and browser software to allow a user to request, receive, and display information. The user computing devices are any means capable of communicating with the servers, including, but not limited, to personal computers, PDAs, email-enabled cell phones and ATM-type terminals. The user computing devices may access servers via a communication network or through some other remote access, such as, for example, by telephone lines.

Users who desire to access the ticketing application may establish a connection on a wide area computer network between a user computing device and a server (e.g., web server). Access to the system may occur through an Internet web site or mobile web site.

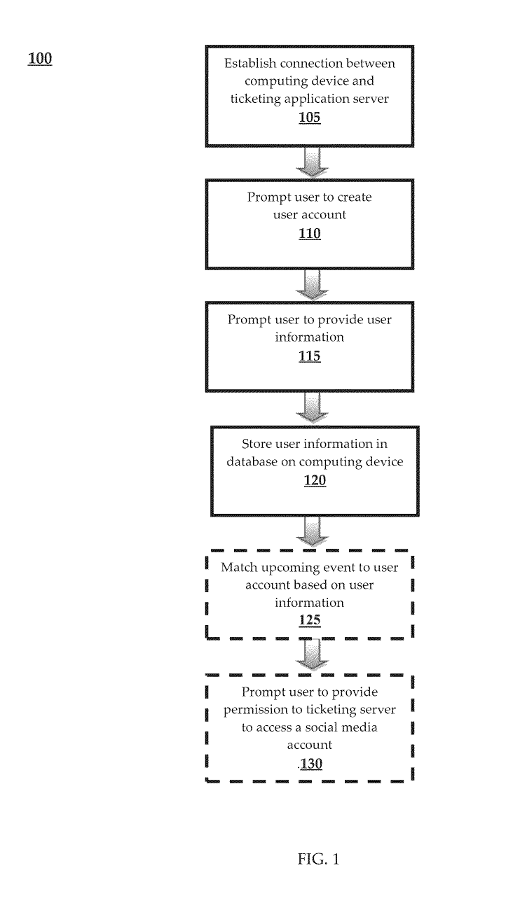

FIG. 1 illustrates a computer-implemented method 100 for gathering market data. A connection is established by way of a communication network between a user computing device, such as a mobile device, and a ticketing application server in step 105.

During a potential user's first visit to the site, the user may be requested to set up an account by clicking on a “Create Account” button or the like, at step 110 of FIG. 1. To create the user account, the user may enter an email address and/or username and password, or similar credentials that allow secure access to the user account.

The user may then be requested to enter additional user information at step 115 of FIG. 1, such as personal and demographic information, including, for example, full or partial name, gender, age or date of birth, physical address or zip code, email address(es), and telephone number. The user may also be requested to complete a user profile by entering information about the user's preferences. Such information may include the types of performances the user prefers to attend, the locations or venues the user prefers, how the user would like to be contacted (e.g., by email, text message, or telephone), and a preferred payment method.

At step 120 of FIG. 1, the user information entered by the user may be saved into the system database. After entering information into the database, the established account may be accessed.

Optionally, at step 125 of FIG. 1, an upcoming event may be matched to a user account, based at least in part on the user information stored in the user account. For example, the user may indicate that she enjoys country music and lives in San Francisco, Calif. Thus, when a country music concert is scheduled to be performed in San Francisco, the ticketing application may notify identify one or more characteristics about the event that match the user information, and notify the user via the preferred communication preference indicated by the user.

Optionally, the user may be prompted to indicate whether the ticketing application has permission to access the user's social media account information (e.g., Facebook or Twitter) at step 130 of FIG. 1. If the user gives permission to the ticketing application to access one or more social media accounts, the ticketing application may, for example, post on the “wall” associated with the user regarding upcoming events of interest, find “friends” of the user who are attending certain events, or send messages to the user.

One or more tickets to an event may be electronically purchased by a user associated with a computing device. The purchased tickets may be digital, e-tickets, or print-at-home tickets (e.g., PDF, HTML, etc.). The event may be any private or public prerecorded, repeat, or live event or performance known in the art such as a concert, sporting event, show, movie, or musical recital. A purchased ticket may be electronically received by the user from the ticket seller or source and saved to a database accessible by the computing device. The ticket may be purchased directly through the ticketing application. Alternatively, the user may choose to load or import on or more received tickets into an application for hosting electronic tickets and accessible by the computing device.

Once the ticket has been successfully purchased or loaded into the ticketing application, the user may transfer the ticket to a recipient. Before initiating the transfer, the recipient may be requested to create an account and complete a user profile. Thus, the ticketing application may collect market data about both users before allowing the ticket transfer.

The ticketing application may also track user activities, including information about ticket purchases and transfers. Information about the type of tickets the user purchases or transfers may include the type of events to which the user frequently purchases tickets, the user's preferred venues or locations, the number of tickets the user purchases or transfers, and other information.

The ticketing application administrator may gather this market data and use it to, for example, promote future events by targeting advertising to users who may be most interesting in purchasing tickets. The information may also be useful for the ticketing application administrator for determining which events are likely to be most popular amongst its users for purposes of selecting events for which the ticketing application will serve as a vendor for tickets. The ticketing application administrator may also provide the gathered market data to other vendors, promoters, advertisers, and other parties who may be interested in the demographic information, preferences, and purchasing behavior of the ticketing application users.

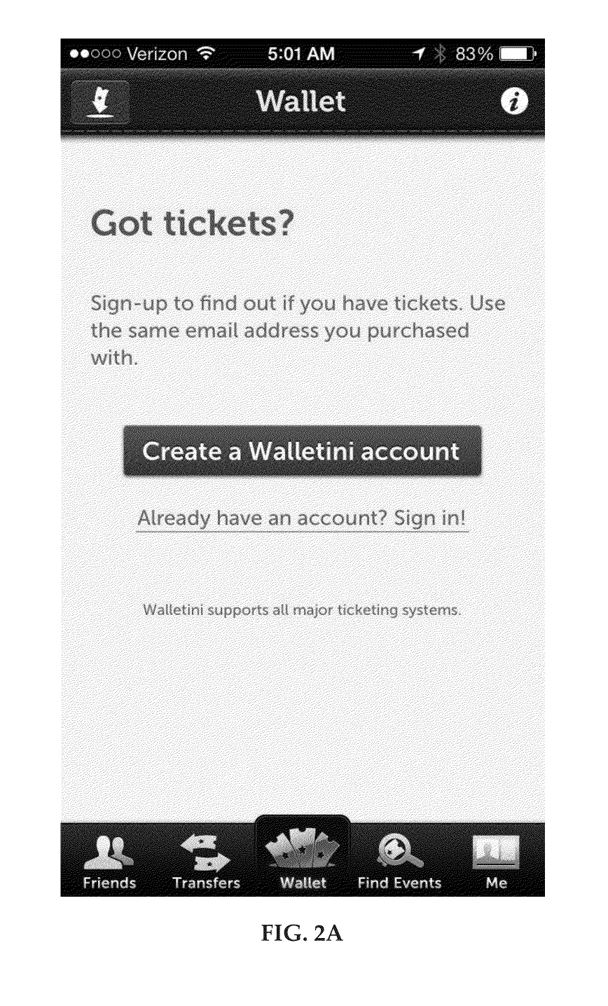

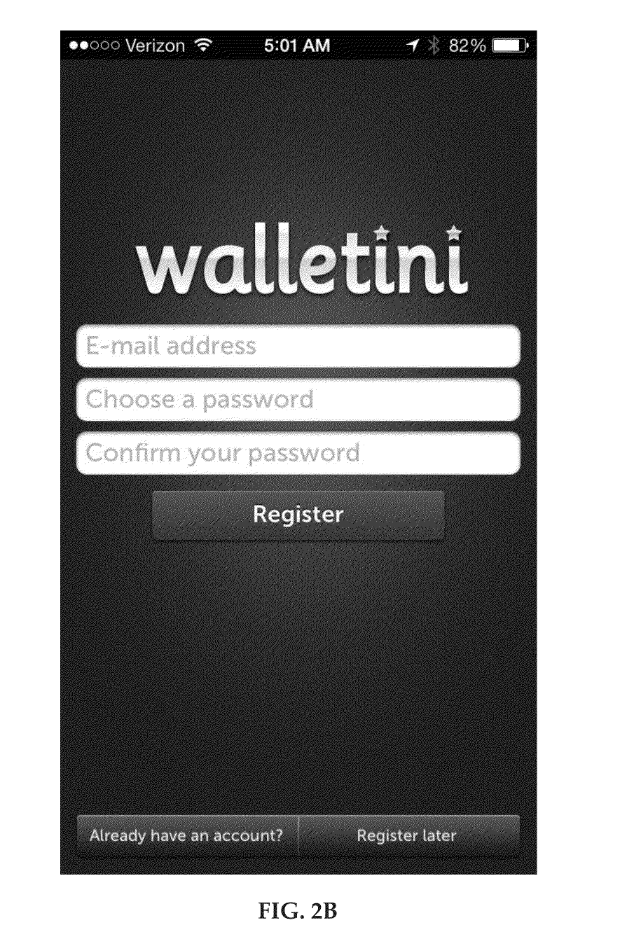

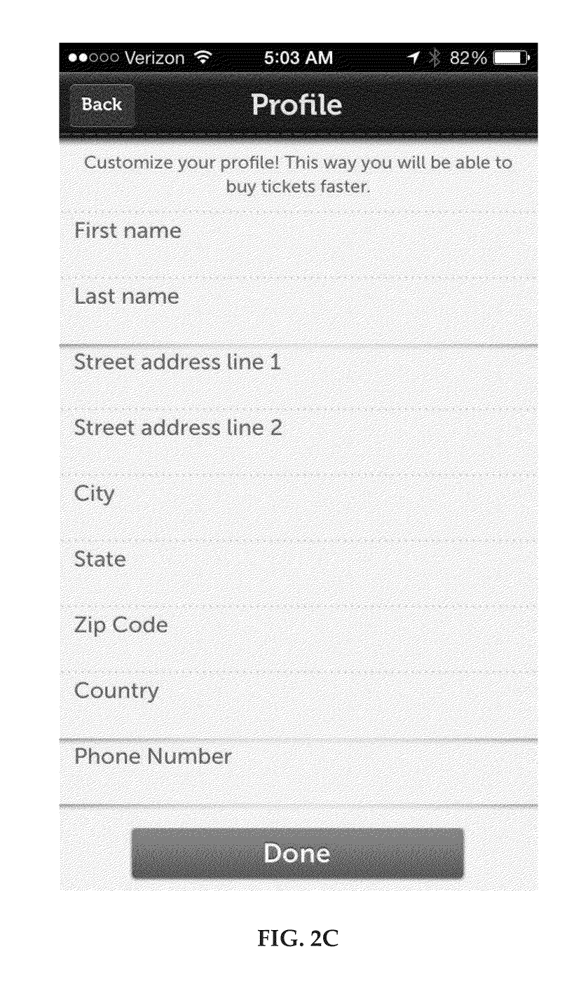

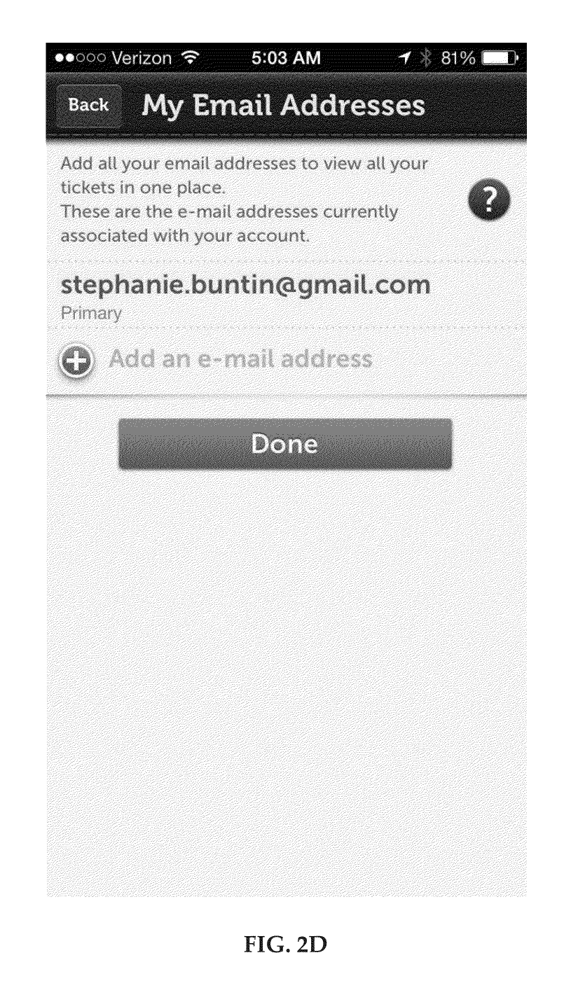

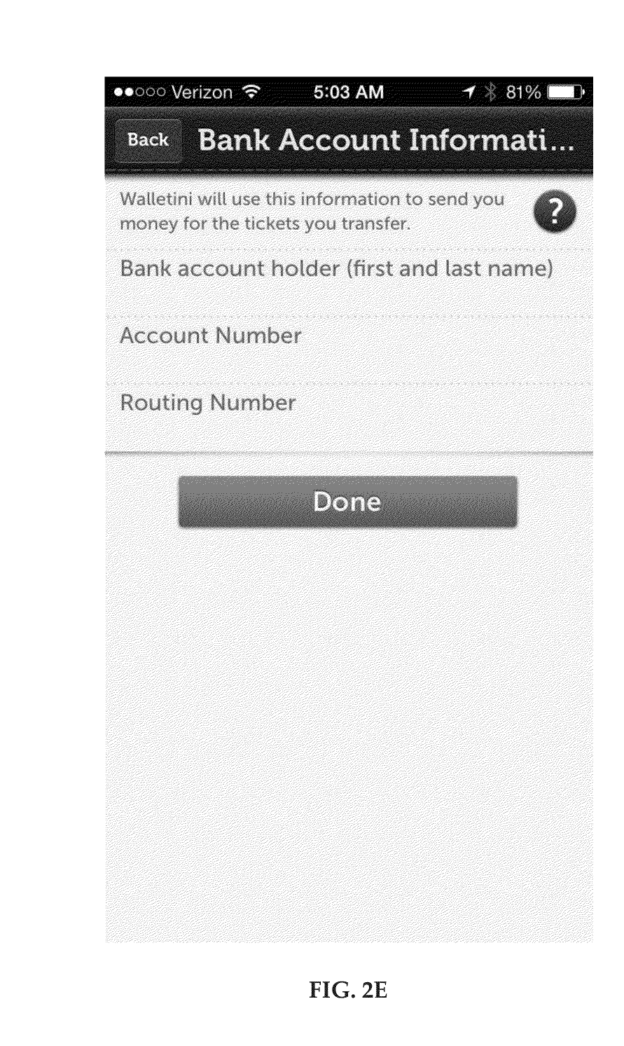

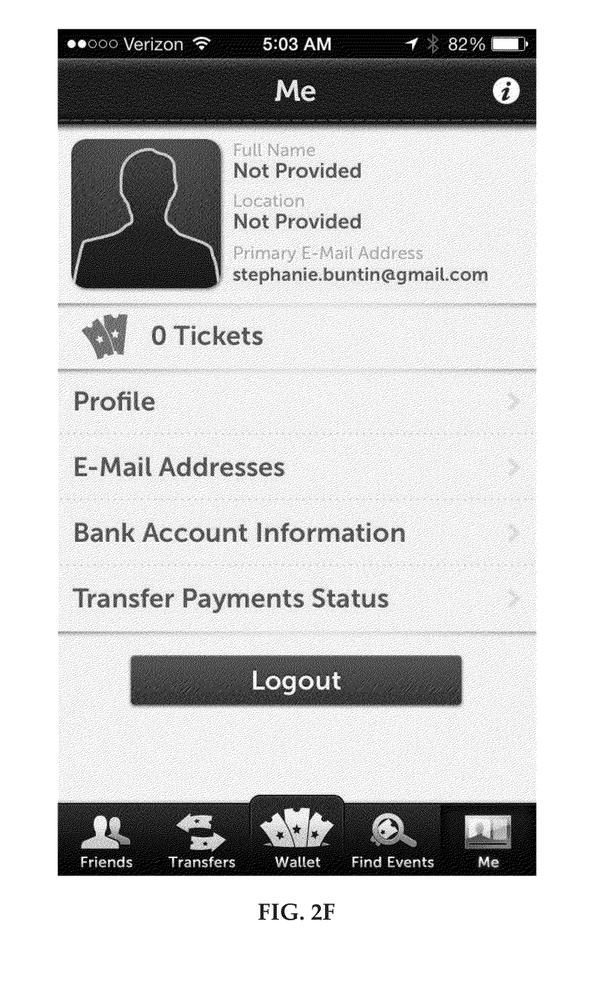

FIGS. 2A-2F illustrate exemplary interfaces for gathering market data, as described in step 100 of FIG. 1.

FIG. 2A illustrates an exemplary graphical interface for prompting a user to create a user account, as described in step 110 of FIG. 1. The user may press a “Create Account” or similar button to register a user account. Alternatively, if the user has already registered, she may bypass this procedure by logging into the ticketing application using her secure credentials, such as a user name and password.

FIG. 2B illustrates an exemplary graphical interface for requesting the user enter login information, as described in step 110 of FIG. 1. Login information may include, for example, an email address and/or username and password, or similar credentials that allow secure access to the user account.

FIG. 2C illustrates an exemplary graphical interface for prompting the user to provide user information associated with the user account on the computing device, as described in step 115 of FIG. 1.

FIG. 2D illustrates an exemplary graphical interface for prompting the user to provide preferred contact information associated with the user, as described in step 115 of FIG. 1.

FIG. 2E illustrates an exemplary graphical interface for prompting the user to provide payment information associated with the user on the computing device, as described in step 115 of FIG. 1.

FIG. 2F illustrates an exemplary graphical interface for a user account, as described in steps 110-125 of FIG. 1.

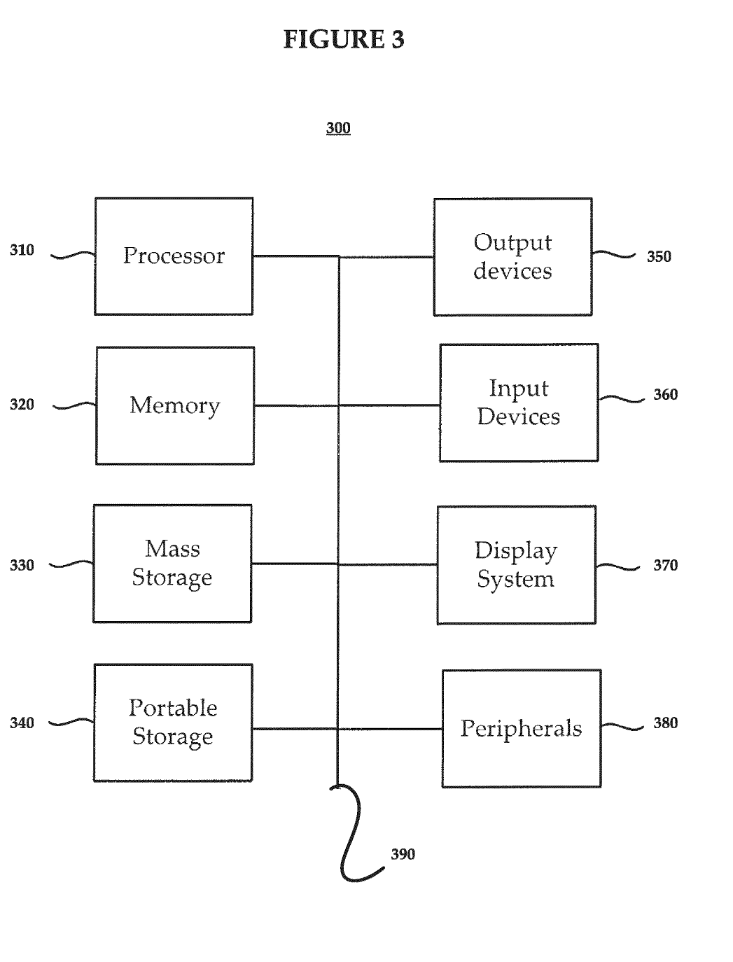

FIG. 3 illustrates a computing system that may be used to implement the method of the present invention. System 300 of FIG. 3 may be used to implement a computing device, network server, application server 150, and/or database operating in the context of the method of FIG. 1. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. The components, however, may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present invention for purposes of loading software into main memory 320.

Portable storage device 340 operates in conjunction with a portable nonvolatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 may receive textual and graphical information, and process the information for output to the display device.

Peripherals 380 may include any type of computer support device to add additional functionality to the computer system. For example, peripheral device(s) 380 may include a modem or a router.

The components contained in the computing system 300 of FIG. 3 are those typically found in computer systems that may be suitable for use with embodiments of the present invention and are intended to represent a broad category of such computer components that are well known in the art. Thus, the computing system 300 of FIG. 3 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A computer-implemented method for gathering market data, the method comprising:
establishing a connection by way of a communication network between a user computing device and a ticketing application server;
prompting a user to create a user account on the computing device;
prompting the user to provide user information associated with the user account on the computing device; and
storing the user information associated with the user account in a system database on the computing device.

2. The method of claim 1, further comprising transferring the stored user information to a third party.

3. The method of claim 1, wherein the user information includes an email address.

4. The method of claim 1, wherein the user information includes the full or partial name of the user.

5. The method of claim 1, wherein the user information includes the gender of the user.

6. The method of claim 1, wherein the user information includes the age of the user.

7. The method of claim 1, wherein the user information includes a physical address.

8. The method of claim 1, wherein the information includes a phone number.

9. The method of claim 1, wherein the user information includes at least one user preference.

10. The method of claim 9, wherein the at least one user preference includes a type of performance of interest to the user.

11. The method of claim 9, wherein the at least one user preference includes at least one geographical location of interest to the user.

12. The method of claim 9, wherein the at least one user preference includes at least one venue of interest to the user.

13. The method of claim 9, wherein the at least one preference includes a preferred method of communication.

14. The method of claim 13, wherein the preferred method of communication includes an indication that the user prefers to be contacted at an email address.

15. The method of claim 13, wherein the preferred method of communication includes an indication that the user prefers to be contacted by telephone.

16. The method of claim 13, wherein the preferred method of communication include san indication that the user prefers to be contacted by text message.

17. The method of claim 9, wherein the at least one preference includes a preferred method of payment.

18. The method of claim 1, further comprising matching an upcoming event to the user account, based at least in part on the user information.

19. The method of claim 1, further comprising prompting a user to provide permission to the ticketing application server to access a social media account associated with the user.

20. A computer-implemented method for gathering market data, the method comprising:
establishing a connection by way of a communication network between a user computing device and a ticketing application server;
prompting a user to create a user account on the computing device;
prompting the user to provide user information associated with the user account on the computing device;
storing the user information associated with the user account in a system database on the computing device;
matching an upcoming event to the user account, based at least in part on the user information; and
prompting a user to provide permission to the ticketing application server to access a social media account associated with the user account.
